(19) United States
(12) Patent Application Publication
(10) Pub. No.: US 2002/0070179 A1
(43) Pub. Date: Jun. 13, 2002

(54) Process and device for supercritical wet oxidation

(76) Inventors: Stephan Pilz, Hanau (DE); Margit Veeh, Ulm (DE); Kolja Rebstock, Ulm (DE)

Correspondence Address: Stephan A. Pendorf, Pendorf & Cutliff, P.O. Box 20445, Tampa, FL, 33622-0445, US

(21) Appl. No.: 10/012,849

(22) Filed: Dec. 10, 2001

(30) Foreign Application Priority Data
Dec. 9, 2000 (DE) 100 61 388.8

(51) Int. Cl. C02F 1/72

(52) U.S. Cl. 210/758; 210/198.1

(57) ABSTRACT

A process and a device for supercritical wet oxidation of a waste material mixture containing particles comprised of organic and inorganic components, which are suspended in water, which is raised to a near critical or supercritical condition and in this condition is passed through a pipe reactor (6). According to the invention the pipe reactor is so arranged, that the organic components substantially dissolve in water substantially without being oxidized. The output products of the pipe reactor are caused to pass through a second reactor (8) in the near or supercritical condition, which has a substantially smaller ratio of internal surface area to volume than the pipe reactor and is so arranged that the organic components are substantially completely oxidized therein.

### BACKGROUND OF THE INVENTION

1. Field of the Invention

The invention concerns a process and a device for supercritical wet oxidation of a waste mixture containing particles comprised of organic and inorganic components, which are suspended in water brought to a near-critical or supercritical condition and in this condition is passed through a pipe reactor.

Water in supercritical condition performs well as a solvent for organic materials, and besides this, as a reaction medium. These characteristics are taken advantage of for hydrothermal processing of waste material mixtures, for example the shredder light fraction from automobile recycling or electronic scrap.

2. Description of the Related Art

A first known reactor concept is a fixed bed reactor, in which the waste material mixture is present as a solid in a bed. Here, however, only relatively small amounts can be handled, in order to avoid too much of a rise in the reaction temperatures in these non-stationary operations. The fixed bed reactor must frequently be opened, and is subjected to dynamic loads. The temperatures and concentrations are unevenly distributed, and the mass transport is hindered by the packing of the solids.

A second reactor concept is a slurry pipe reactor. In the framework of the BMBF-conveyor arrangement for preparing and recycling electronic junk by supercritical wet oxidation (conveyor reference number 01RK9632/8 and 01RK9633/0) a test line was constructed, in which a reactor in the shape of a horizontal, narrow, longitudinally extending pipe is flowed through with water in the near or supercritical condition, in which the waste material particles are suspended and are maintained in suspension by a high flow-through speed, that is, the therewith associated turbulence. In the pipe reactor the organic components are dissolved, cracked or decomposed and oxidized.

A pipe reactor can on the one hand be operated continuously; however the reactor wall suffers not only from abrasion due to the rapidly moving waste material particles, but rather at the same time, it suffers from corrosion due to the near or supercritical water and the therein contained components, and in particular the already decomposed organic components. A further problem is an inadequate space-time yield; the reactor must be relatively long so that the waste material mixture has sufficient residency time therein so that a complete decomposition is achieved.

### SUMMARY OF THE INVENTION

These problems are solved by a process and a device according to the invention.

In the invention a pipe reactor and a second, a bulbous reactor, are arranged sequentially and operated continuously, in order to separate and treat a complex waste mixture utilizing the characteristics of supercritical water, and wherein the organic material containing component is chemically decomposed.

The separation into two reactors combines the individual advantages of both along the process chain with respect to thermal input and output, abrasion and corrosion, space and energy requirements, control concepts and safety:

The bringing into solution of the organic components occurs substantially in the pipe reactor, and the oxidation of the organic components occurs essentially in the second reactor. The hydrolysis or cleavage of the organic components can already occur in the pipe reactor. It is however not critical, whether the hydrolysis partially or primarily first occurs in the second reactor. The different processes during the decomposition of the organic components, namely bringing into solution, hydrolysis and oxidation, can in practice not be exactly separated from each other, since they occur partially parallel to each other. However one can cause by suitable arrangement of the two reactors that the bringing into solution occurs most predominately in the pipe reactor and the oxidation occurs most predominantly in the second reactor.

Since the bringing into solution normally occurs more rapidly than hydrolysis and substantially more rapidly than oxidation, the pipe reactor can be designed to be substantially shorter than the pipe reactor according to the state of the art in which all three mentioned reactions occur. The second reactor is in any case relatively compact. Thus the invention makes possible overall a substantially more compact manner of construction than a pipe reactor according to the state of the art.

Since the pipe reactor is substantially shorter than a pipe reactor according to the state of the art in which all three mentioned reactions occur, problems of clogging are minimized.

In the conventional pipe reactor the energy requirement in order to convey the water with the therein suspended particles with high speed through the long, narrow pipe, is substantial. In the substantially shorter pipe reactor of the present invention the energy requirement for the conveyance is substantially smaller. The first reactor energy saving more than compensates for the additional energy required for the conveyance through the second reactor, since conveyance through a bulbous tank requires relatively little energy.

Since in the pipe reactor only little hydrolysis and oxidation occurs, the material thereof may be subjected to abrasion, however is only exposed to little corrosion. In the second reactor the flow velocity on the basis of the more bulbous design is substantially less than in the pipe reactor, and thus the material of the second reactor may be subjected to corrosive forces but is only subjected to little abrasion. It is substantially easier to find a material which in the proximity of the critical condition of water is either corrosion resistant or abrasion resistant, than it is to find a material which in the existing conditions is both corrosion resistant as well as abrasion resistant. This substantially increases the selection of reactor construction materials, and the life expectancy of the reactors can be substantially prolonged.

In order to guarantee the complete oxidation of all organic components, one could introduce into the process water, at some point prior to the second reactor, an oxidation agent such as, for example, oxygen. If the oxidation agent is introduced prior to or directly into the second reactor, then corrosion in the first reactor can be minimized.

The inventive installation is particularly suited for treatment of waste materials with high halogen component. The presence of halogen normally has a particularly intensive corrosion as a consequence. However, according to the present invention, in the pipe reactor the halogens are substantially bonded in the polymer chains, and salts resulting from halogens rapidly precipitate, since inert materials present in the waste material mixture act as crystallization nucleating agents.

The reactor is preferably a PFR (Plug Flow Reactor), a long, narrow reactor, which is characterized by high flow velocity. As a result of the turbulence associated therewith, generally an overall good radial mixing occurs, which prevents a sedimentation or precipitation of the particles. On the other hand, the ideal PFR has no back mixing, that is, no axial mixing. As a result of its large relationship of internal surface to volume, thermal energy can be easily introduced and removed. Accordingly local continuous reactions can be avoided, and an even temperature and concentration profile is established over the length of the PFR.

The second reactor is preferably a CSTR (Continuously Stirred Tank Reactor), a bulbous tank with stirrer. The stirrer brings about a complete mixing through of the liquid components in the entire reaction space. Accordingly, concentrations and temperatures within the reactor are locally constant. Due to the low relationship of internal surface area to volume, thermal energy can only relatively slowly be introduced or removed. However, a greater portion of the reaction thermal energy is already removed in the pipe reactor. If necessary, cold water can be added to the second reactor, in order to reduce the fuel or caloric value for the further reaction.

In the second reactor relatively long dwell times can be realized in small construction volumes, which make possible a complete decomposition of the organic components. As a consequence of the good mixing through during stirring, the dwell time need not be extremely high.

As a result of the bulbous shape of the second reactor, particular measures can be met, which minimize the corrosion exposure of the reactor construction material. For example the reactor walls can be cooled, while the reaction primarily occurs in a hot core zone.

In the second reactor no consideration must be given to sedimentation, since the remaining organic materials, namely inert materials, precipitated salts and other solids, are irrelevant for hydrolysis and oxidation. Despite the stirring in the second reactor, a certain amount of precipitation of the particles out of mixture will occur, this is however likewise irrelevant. The particles can simply fall through the reactor more or less rapidly and later be removed. Alternatively, the particles can be separated using a separator before they enter into the second reactor. In this case however the separator must be able to withstand the conditions which exists in the proximity of the critical point of water.

The inventive supercritical wet oxidation process for chemical decomposition of waste materials is characterized thereby, that it is advantageous not only for treatment of electronic waste and waste water and sewage sludge, but rather also for treatment of shredder light fraction from automobile recycling. The later waste material mixture, which is in large part comprised of plastic, is presently encountered in particularly large amounts. In contrast to many conventional thermal treatment processes, the inventive process is not a retainer of toxins, and further, no new toxins such as dioxane are produced. Instead, for all materials the life cycle can be closed and the recycling quotient can be substantially increased.

### BRIEF DESCRIPTION OF THE DRAWINGS

Further characteristics and advantageous embodiments can be seen in the appended patent claims and from the following description of two illustrative embodiments by reference to the drawings. There is shown:

FIG. 1 the density and dynamic viscosity of purer water as a function of the temperature at a pressure of 25 MPa,

FIG. 2 the dielectric constant and the ion product for pure water at a pressure of 25 MPa, as a function of temperature,

FIG. 3 the solubility of organic and inorganic materials in water as a function of temperature at pressures of 22.1 to 30 MPa,

FIG. 4 the density of pure water and the diffusion coefficient of a strongly diluted benzole solution as a function of temperature at a pressure of 25 MPa,

FIG. 5 a schematic diagram of an installation for supercritical wet oxidation of a waste material mixture in two stages according to a first embodiment and

FIG. 6 a schematic diagram of a facility for supercritical wet oxidation of a waste material mixture in two steps according to a second embodiment.

### DETAILED DESCRIPTION OF THE INVENTION

A supercritical fluid is a fluid with a temperature above the so-called critical temperature and a pressure above the so-called critical pressure, wherein in the phase diagram the point with the critical temperature and the critical pressure is referred to as the critical point. In the supercritical condition no distinction is possible between liquid and gas. The characteristics of a supercritical fluid can be gas-like as well as liquid-like, depending upon temperature and pressure.

In supercritical wet oxidation various characteristics of supercritical water are taken advantage of, for example the very good solvent behavior for organic materials and for gases as well as good behavior as a reaction medium (Clifford A. A.: Chemical destruction using supercritical water; In: Clark J. H. (ed.): Chemistry of Waste Minimization; 1995).

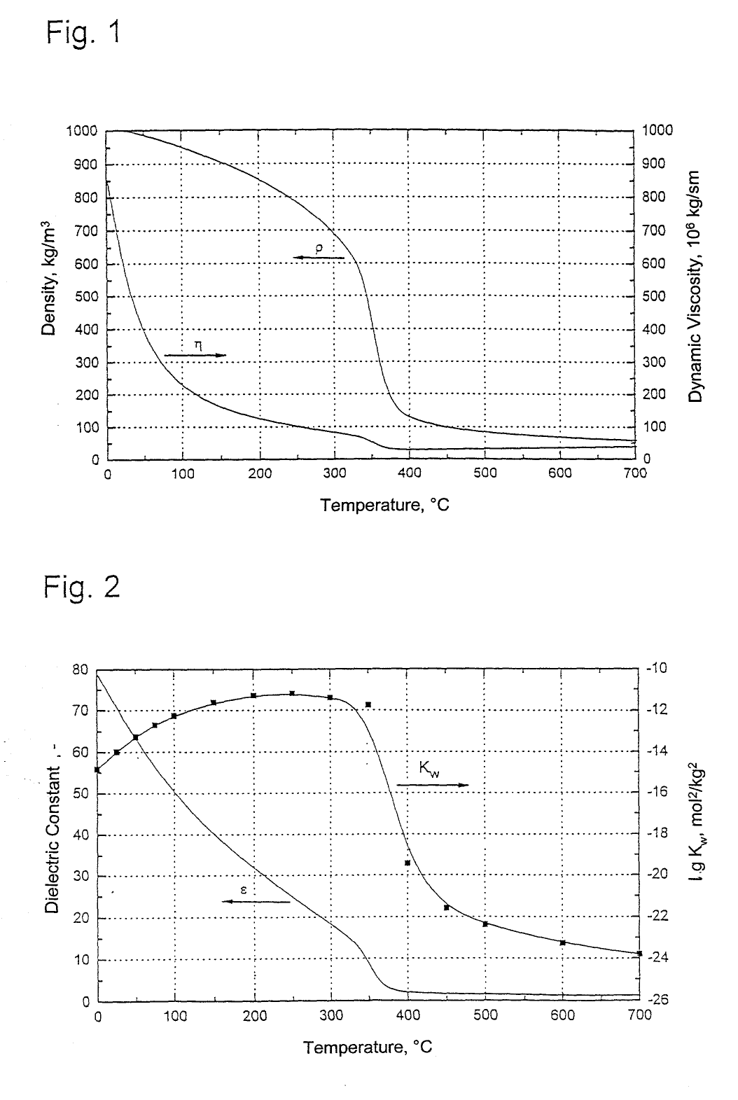

In the supercritical region (for water—the other side of 374° C. and 22.1 MPa) the material characteristics change. Among other things the density of water is reduced by approximately a factor of 10 in comparison to ambient conditions, and at the same time the dynamic viscosity drops by a factor of 20, see FIG. 1, which shows the density ρ and the dynamic viscosity η for pure water as a function of temperature at a pressure of 25 MPa. Therewith the density continues to remain liquid-like, while the viscosity assumes values of gases.

FIG. 2 shows the dielectric constant ε and the ion product K_{W} for pure water at a pressure of 25 MPa as a function of temperature. The drop of the dielectric constant ε in the supercritical state is explained chemically by the removal of the hydrogen secondary bond formation, that is, water as it approaches the critical point is increasingly less polar, and in the supercritical water behaves almost non-polar (Clifford, A. A.: see above). Besides this, the ion product increases strongly by several tens of percent, that is, the conductivity increases correspondingly.

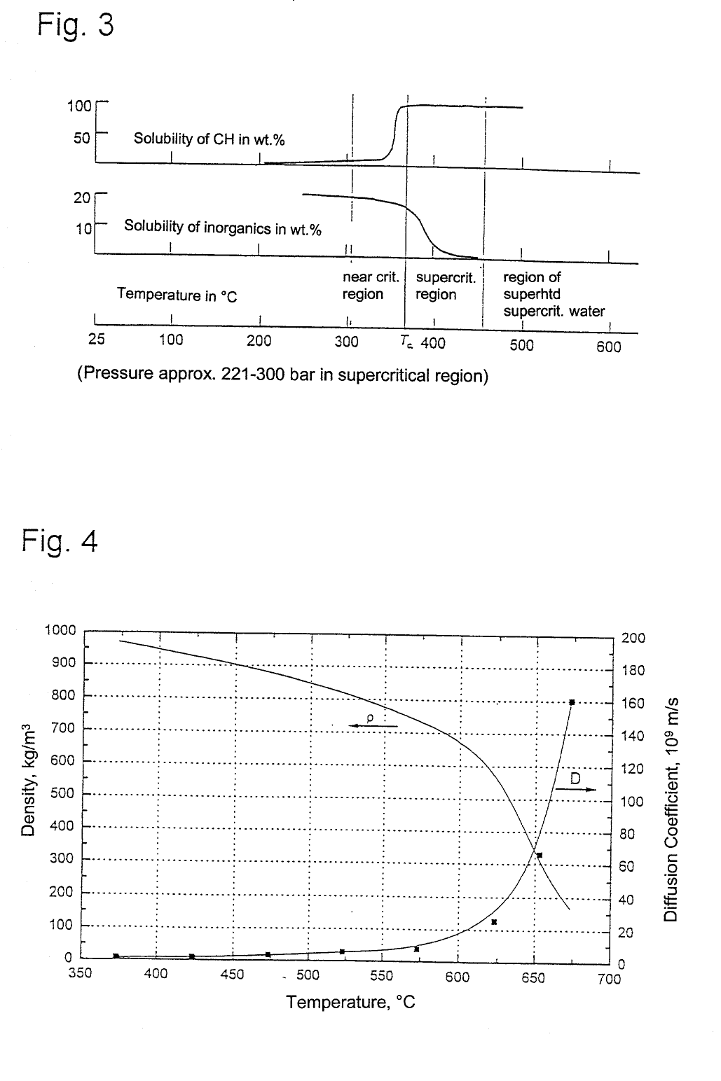

The resulting change in solubility can be seen in FIG. 3, which shows the solubility of organic (CH, carbohydrates) and inorganic materials in water as a function of temperature; the measurements occurred at supercritical pressures of 22.1 through 30 MPa. Carbohydrates had almost unlimited solubility beginning at the near critical region, while in contrast on the other side of the critical temperature the solubility of inorganic materials strongly dropped (Modell, M.; Paulaitis, M. E.: Supercritical Fluids; Environ. Sci. Technol.; Vol. 16; No. 10, 1982).

One indicator for the behavior as a reaction medium is FIG. 4, which shows the density ρ of pure water and the diffusion coefficient D of a strongly diluted benzole solution as function of temperature at a pressure of 25 MPa (Caroll, J. C.: Ph.D. Thesis, University of Leeds, UK, 1992). The high diffusion of the water in the supercritical region causes the reactions to be determined not only by material exchange, but rather primarily by the kinetics.

Determined by the high solubility of organic materials and of gases in supercritical water, the relevant reactive system lies between polymers, water and oxygen as a single phase. With the aid of high diffusion there result rapid reactions, which in general lie in the range of minutes, while other thermal chemical processes require hours or days.

In the treatment of solid waste materials by supercritical wet oxidation the solids are dispersed in water and bought to the supercritical pressure. Subsequently the temperature is increased to the desired range, preferably into the supercritical range.

The organic components go into solution and are hydrolytically partially decomposed. By the addition of an oxidation agent, for example oxygen, H₂O₂ or air, the decomposition is completed. The organics are converted into carbon dioxide, water and molecular nitrogen. Any halogens present are transformed into corresponding salts. For this, metals which may be present serve as cation donors. Otherwise, the metals oxidize and act catalytically on the reaction. In the case of the presence of ceramic components these do not have an affect on the chemical processes. They remain insoluble in all conditions. Likewise insoluble are the produced salts at usual conditions of supercritical wet oxidation (250-300 MPa, 500-600° C.). It is also conceivable to use very high pressures—up to 1000 MPa—to keep the salts in solution.

At the end of the reaction phase the temperature is dropped and there is a return to environmental pressure. Subsequently the reaction products are separated from each other into the phases “gas”, “liquid” and “solids”.

In the treatment of solids by supercritical wet oxidation there exist a series of difficulties or problems. Supercritical water already places increased stresses on the material due to the combination of high pressure (23-30 bar) and increased temperatures (400-600° C.) as well as strongly acidic conditions. The occurrence of a reaction, as well as abrasion due to solids, further increases the stresses. Particularly problematic is the presence of halogens. Here the highest corrosion erosion occurs at the critical (T=374° C.) or, as the case may be, pseudo critical temperature (the pseudo critical temperature is the temperature shifted to higher temperatures depending upon pressure, for example 405° C. for a pressure of 30 MPa). One solution is to keep the process parameters as mild as possible, for example by lowing the temperature, and by appropriate process design or, as the case may be, by the design of the reactor to decouple the stresses, for example by flowing a cold layer along the reactor wall. In the first example, the lower temperatures, longer dwell times are necessary for the same decomposition rate, as a result of which one requires a larger unit. The second example, cold boundary layer flow, requires elaborate constructive measures.

A further difficulty in the treatment of solids by supercritical wet oxidation is sedimentation, the tendency of the particles to deposit to the floor of the arrangement. On the basis of the changed fluid characteristics in the supercritical range as compared to ambient conditions the rates of precipitation of introduced solid particles substantially increases. The sedimentation can be avoided in that one employs a horizontal pipe reactor. At appropriate high flow-through speeds the suspension remains stable. Research has shown that it is less problematic to keep the suspension stable in supercritical water than in liquid water. That is, with decreasing density the flow speed in the pipe reactor increases inversely proportionally and overcompensates for the higher precipitation speeds (Pilz, S.: Modeling, Design and Scale-Up of an SCWO Application Treating Solid Residues of Electronic Scrap Using a Tubular Type Reactor-Fluid Mechanics, Kinetics, Process Envelope, VDI-GVC High Pressure Chemical Engineering Meeting; 03-05, March 1999, Karlsruhe).

A suspension reactor is exposed to increased abrasion due to the solid particles. The use of devices (valves, measurement devices) results in further difficulties or problems on the basis of changes of the pipe internal diameter and stronger changes in the flow direction. Here particles, in particular fibers, can lead to clogging. On the basis of the higher flow velocities there results a longer reactor and a not very compact construction.

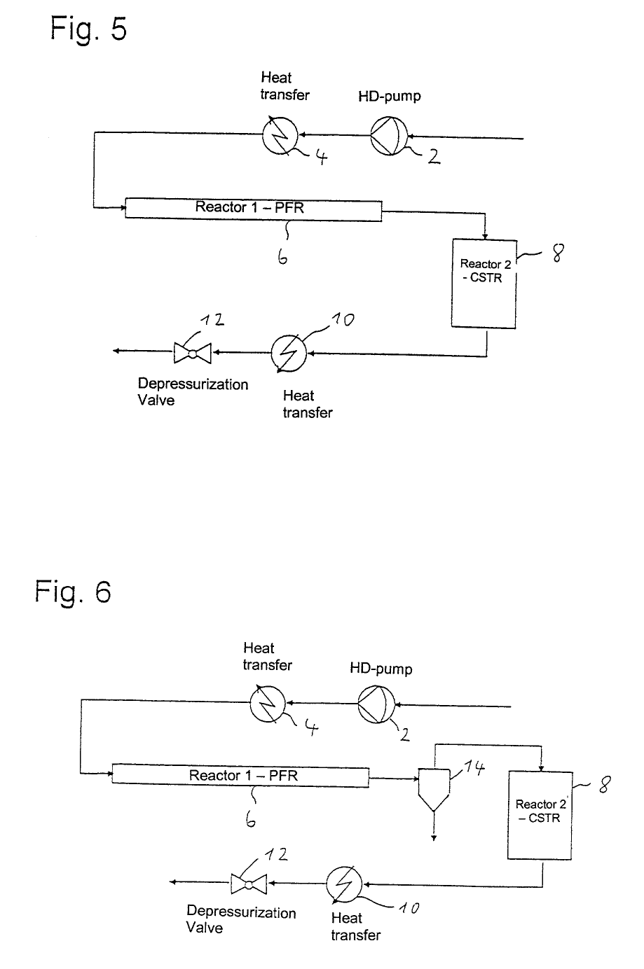

FIG. 5 is a schematic diagram of a first embodiment for the installation for supercritical wet oxidation of a waste material in two stages. The installation includes a high pressure pump 2, a first heat exchanger 4, a PFR (Plug Flow Reactor; long, narrow pipe reactor) 6, a CSTR (Continuously Stirred Tank Reactor; bulbous tank with stirring) 8, a second heat exchanger 10 and an expansion valve 12. These components are connected with each other by pipe conduits, as schematically indicated.

A waste material mixture to be treated in the apparatus, for example electronic debris or waste products or the shredder light fraction from automobile recycling, is shredded in a not shown unit and is suspended in water. This water with the therein suspended waste material particles are introduced into a high-pressure pump 2 wherein this raises the pressure to near the critical pressure and introduced into a first heat exchanger 4. In the heat exchanger 4 the water with the therein suspended particles is supplied with heat from outside, in order to raise it to a temperature near the critical temperature.

The hot water under pressure with the therein suspended particles first flows through the PFR 6 and then through the CSTR 8. The mixture leaving the CSTR 8 is subjected to thermal removal in the second heat exchanger 10, in order to cool it to the proximity of the ambient temperature, and the expansion valve 12 reduces the pressure of the mixture to the ambient pressure.

Further, at some point prior to PFR 6 or CSTR 8 an oxidation agent such as oxygen is introduced, in the case that the mixture of water and waste material does not have sufficient oxidation agent from the start. Due to the good mixing through within the CSTR 8 the oxidation agent could also be introduced directly in the CSTR 8.

In not shown further installation components, gaseous reaction products, salts produced in the reactors, as well as solids which have not reacted, are extracted from the water and separately recycled. The remaining water can be reintroduced into the cycle, for example in the case it still contains impurities, which would be too difficult to remove.

The PFR 6 and the CSTR 8 are so arranged, that of the three sequential and partially also simultaneously occurring decomposition steps

1) solublization of organics

2) hydrolysis and

3) oxidation of the organics

the step 1) essentially occurs in the PFR 6, and step 3) occurs essentially in the CSTR 8. This division is easily possible, since under the same conditions the solubilization occurs substantially more rapidly than the oxidation.

The appropriately arranged PFR 6 is substantially shorter than a pipe reactor in which all three decomposition steps must occur. The PFR 6 may be subjected to abrasion by the solids, which are conveyed with high speed, so that they do not deposit; however the abrasion can be more easily dealt with, since less reactor material is subjected to abrasion and thus after depletion less reactor material must be replaced. Besides this, the life expectancy of the reactor material is increased thereby, that essentially no aggressive reaction products are present in the PFR 6, so that is there is less exposure to corrosion. Further, the relatively short PFR 6 is less liable to clogging problems.

The hydrolysis, the partial splitting or cleaving of the reaction educts by the ions present in the water, can either occur in the PFR 6 or in the CSTR 8. Normally a part of the hydrolysis will occur in the PFR 6 and another part will occur in the CSTR 8, so that the organics are present at least as a solution between the PFR 6 and the CSTR 8, partially however are also already decomposed to short chain polymers.

The CSTR 8 has a substantially larger ratio of volume to inner surface area than the PFR 6. Thus the flow velocity in the CSTR 8 is substantially lower than in PFR 6. Due to the low flow velocity the reactor material of the CSTR 8 is subject to little abrasion. There is exposure to corrosion attack due to reaction products, however there are many suitable tolerant materials for the CSTR 8, as long as there is no concern over strong abrasion.

In the CSTR 8 there occurs, due to its stirrer, a complete mixing-through in the entire reaction space. The good mixing-thorough lowers the reaction time and therewith the dwell time, which for oxidation is normally longer than for the first two decomposition steps. Thus the CSTR 8 need not have a disproportionately large volume in order to achieve a sufficient dwell time for the materials to be decomposed. On the basis of the good mixing through, the reactions in the CSTR 8 run particularly uniformly, so that extensive instrumentation for avoidance of defects or discontinuities is not necessary. In the PFR 6 such an instrumentation may be necessary; however, due to the short construction length less control instrumentation is necessary, for example pressure measuring devices.

Besides this, due to the bulbous construction of the CSTR 8 it is easier than in the PFR 6 to introduce corrosion preventing and kinetic improving measures such as coating or internal components. Corrosion preventing coatings and internal components, which protect the reactor wall for example using cooler zones, makes possible higher reaction temperatures and results in correspondingly shorter reaction times.

The volume remaining in the framework and the large ratio of volume to internal surface area in the CSTR 8 makes possible a very compact construction. The space requirement for the CSTR 8 is less than amount by which length of the PFR 6 was economized. Thus, overall a very compact installation can be realized.

A CSTR has the inherent disadvantage that, due to the small ratio of internal surface area to volume, heat can only be added or extracted relatively slowly. A continuous reaction is difficult to control in this type of reactor. Since however a substantial portion of the reaction heat already occurs in PFR 6 and can be removed there due to the relatively large surface area, the investment in reaction control in the CSTR 8 is lower.

In the CSTR 8 no provision need be made for sedimentation, since the solids remaining are irrelevant for the reactions occurring therein. The particles can simply precipitate through the CSTR 8 and later be removed.

FIG. 6 shows a second embodiment for a device for supercritical wet oxidation of a waste material in two stages, which differs from the installation in FIG. 5 only by a supplemental high pressure separator 14, which is inserted between the PFR 6 and CSTR 8. In the high-pressure separator 14 the solids produced in the PFR 6 are separated, in order to minimize the abrasive exposure of the subsequent installation parts.

In summary the division of the reaction into two segments combines the individual advantages of the two continuously operated reactor types PFR and CSTR. In a first segment the solid organic components are transformed into a liquid phase, wherein the decomposition of the organics occur in the background. In a second segment the complete decomposition of the organics is carried out.

For this, first a PFR with high flow velocity is employed for a stable suspension conveyance. Temperature spikes which may occur are removed by the narrow geometry. Subsequently a CSTR is operated, which for the same reaction time can be constructed substantially more compact than a PFR. In addition one achieves by the good mixing-through a reduction in the required dwell time.

What is claimed is:

1. Process for supercritical wet oxidation of a waste material mixture containing particles of organic and inorganic components, which are suspended in water, which is raised to a new critical or supercritical condition and in this condition is passed through a reactor, thereby characterized, that the reactor (6) is so arranged,
that the organic components substantially dissolve in water substantially without being oxidized, and
that the output of the pipe reactor is caused to pass through a second reactor (8) in the near or supercritical condition
which has a substantially smaller ratio of internal surface area to volume than the pipe reactor and
that is so arranged, that the organic components are substantially completely oxidized therein.

2. Process according to claim 1, thereby characterized, that the particles are kept in suspension in the pipe reactor (6) by the flow through velocity of the water.

3. Process according to claim 1 or 2, thereby characterized, that the output of the pipe reactor (6) together with any particles remaining therein are conveyed to a second reactor (8).

4. Process according to claim 1 or 2, thereby characterized, that particles, which may be contained in the output of the reactor (6), are separated, prior to the rest of the output product being introduced to the second reactor (8).

5. Process according to one of preceding claims, thereby characterized, that the waste material mixture is electronic waste or a schredder light fraction from automobile recycling.

6. Device for supercritical wet oxidation of a waste material, which contains particles of organic and inorganic components, which are suspended in water, wherein the device
includes a pump and heat device (2, 4), which are arrange such that,
the water with the particles suspended therein can be brought to a near critical or supercritical condition,
and
includes a subsequent pipe reactor (6),
thereby characterized,
that the pipe reactor is so arranged,
that the organic components substantially dissolve in water therein, substantially without being oxidized, and
that a second reactor (8) is connected downstream of the pipe reactor,
which has a substantially smaller ratio of internal surface area to volume than the pipe reactor and
is so designed, that the organic components are substantially completely oxidized therein.

7. Device according to claim 6, thereby characterized, that the pipe reactor (6) is designed for high flow velocity, in order to keep particles in suspension therein by the flow of the water.

8. Device according to claim 6 or 7, thereby characterized, that the second reactor (8) includes a stirrer.

9. Device according to one of claims 6 through 8, thereby characterized, that the output of the pipe reactor (6) and the input of the second reactor (8) are directly connected with each other.

10. Device according to one of claims 6 through 8, thereby characterized, that the output of the pipe reactor (6) and the input of the second reactor (8) are connected with each other via a particles separator (14).
